(19) United States
(12) Patent Application Publication
(10) Pub. No.: US 2012/0013517 A1
(43) Pub. Date: Jan. 19, 2012

(54) INTEGRATED LENS ANTENNAS FOR MULTI-PIXEL RECEIVERS FOR PLANETARY AND ASTRONOMICAL INSTRUMENTS

(75) Inventors: Choonsup Lee, La Palma, CA (US); Goutam Chattopadhyay, Pasadena, CA (US); Nuria Llombart, Madrid (ES)

(73) Assignee: CALIFORNIA INSTITUTE OF TECHNOLOGY, Pasadena, CA (US)

(21) Appl. No.: 13/160,092

(22) Filed: Jun. 14, 2011

Related U.S. Application Data
(60) Provisional application No. 61/354,579, filed on Jun. 14, 2010.

(51) Int. Cl. H01Q 15/08; H01P 11/00

(52) U.S. Cl. 343/785; 29/600

(57) ABSTRACT

Methods and apparatus for integrating lens antennas for receivers are disclosed. A method of fabricating a lens in accordance with one or more embodiments of the present invention comprises integrating lens material with a dielectric material and flowing the lens material into a desired lens shape. An integrated lens antenna in accordance with one or more embodiments of the present invention comprises a dielectric material, a waveguide feed, coupled to the dielectric material through a leaky wave cavity, and a lens, coupled to the dielectric material opposite the leaky wave cavity, wherein material is first deposited onto the dielectric material, flowed into a desired lens shape and the desired lens shape is transferred to the dielectric material.

### CROSS REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 61/354,579, filed on Jun. 14, 2010, by Choonsup Lee, Goutam Chattopadhyay, and Nuria Llombart Juan, entitled “INTEGRATED LENS ANTENNAS FOR MULTI-PIXEL RECEIVERS FOR PLANETARY AND ASTRONOMICAL INSTRUMENTS,” attorneys' docket number CIT-5380-P2,

which application is incorporated by reference herein.

### BACKGROUND OF THE INVENTION

1. Field of the Invention

This invention relates to antennas and detectors used in astrophysics and planetary experiments, and methods for creating antenna lens arrays for use in spectroscopy and other applications.

2. Description of the Related Art

Space exploration and astrophysical studies have been undertaken by several countries for several decades. Current trends in experimentation, such as Cosmic Microwave Background (CMB) or high-resolution spectroscopy in the millimeter wave and sub-millimeter wave arenas, as well as planned planetary experiments, are expected to require large focal planes with thousands of detectors, in order to provide enough data for analysis.

Feedhorns for such focal planes typically have excellent performance, but the mass, size, and fabrication challenges for such feedhorns, as well as the costs for such devices, typically make a feedhorn approach cost prohibitive for very large focal planes.

A highly desirable solution to these problems would be to fabricate a monolithic array of antennas on a planar substrate. However, most planar antenna designs produce broad beam patterns, and therefore require additional elements for efficient coupling to the telescope optics, such as substrate lenses or micro-machined horns. This does not necessarily preclude their use in large arrays, and indeed large arrays using substrate lenses are being investigated; however, the issues of manufacture and assembly of a large “fly's eye” array of lenses makes such designs difficult and expensive. While it is also possible to place an array of antennas behind a single lens, optical aberrations limit the size of such an array.

It can be seen, then, that there is a need in the art for lenses for millimeter wave and sub-millimeter wave optics. It can also be seen that there is a need in the art for these lenses to be lightweight and easily manufactured.

### SUMMARY OF THE INVENTION

To overcome the limitations in the prior art, and to overcome other limitations that will become apparent upon reading and understanding the present specification, the present invention discloses methods and apparatus for integrating lens antennas with receivers. A method of fabricating a lens in accordance with one or more embodiments of the present invention comprises integrating lens material with a dielectric material and flowing the lens material into a desired lens shape. An integrated lens antenna in accordance with one or more embodiments of the present invention comprises a dielectric material, a waveguide feed, coupled to the dielectric material through a leaky wave cavity and a waveguide iris, and a lens, coupled to the dielectric material opposite the leaky wave cavity, wherein material is first deposited onto the dielectric material and then flowed into a desired lens shape.

### BRIEF DESCRIPTION OF THE DRAWINGS

Referring now to the drawings in which like reference numbers represent corresponding parts throughout:

FIG. 1 illustrates a side view of a lens array in accordance with one or more embodiments of the present invention;

FIGS. 2A-2E illustrate formation of a lens in accordance with one or more embodiments of the present invention;

FIG. 3 illustrates a lens structure in accordance with one or more embodiments of the present invention;

FIG. 4 is a flowchart illustrating a method of fabricating a lens in accordance with one or more embodiments of the present invention;

FIG. 5 is an array of fabricated lenses in accordance with one or more embodiments of the present invention;

FIG. 6 is the fabricated lens array plus the integrated antenna (i.e. waveguide and leaky wave cavity) in accordance with one or more embodiments of the present invention; and

FIG. 7 is the fabricated waveguide iris used to match the antenna impedance in accordance with one or more embodiments of the present invention.

### DETAILED DESCRIPTION OF THE INVENTION

In the following description of the preferred embodiment, reference is made to the accompanying drawings, which form a part hereof, and in which is shown by way of illustration a specific embodiment in which the invention may be practiced. It is to be understood that other embodiments may be utilized and structural changes may be made without departing from the scope of the present invention.

Overview

The present invention discusses integrated silicon micro lenses which can be fabricated photolithographically. These lenses can be fabricated as a single lens or as an array of lenses. The present invention's approach eliminates manual assembly of lens arrays and also reduces assembly errors and tolerances. Moreover, an antenna array without metallic horns as described with respect to the present invention reduces the mass of any planetary instrument significantly.

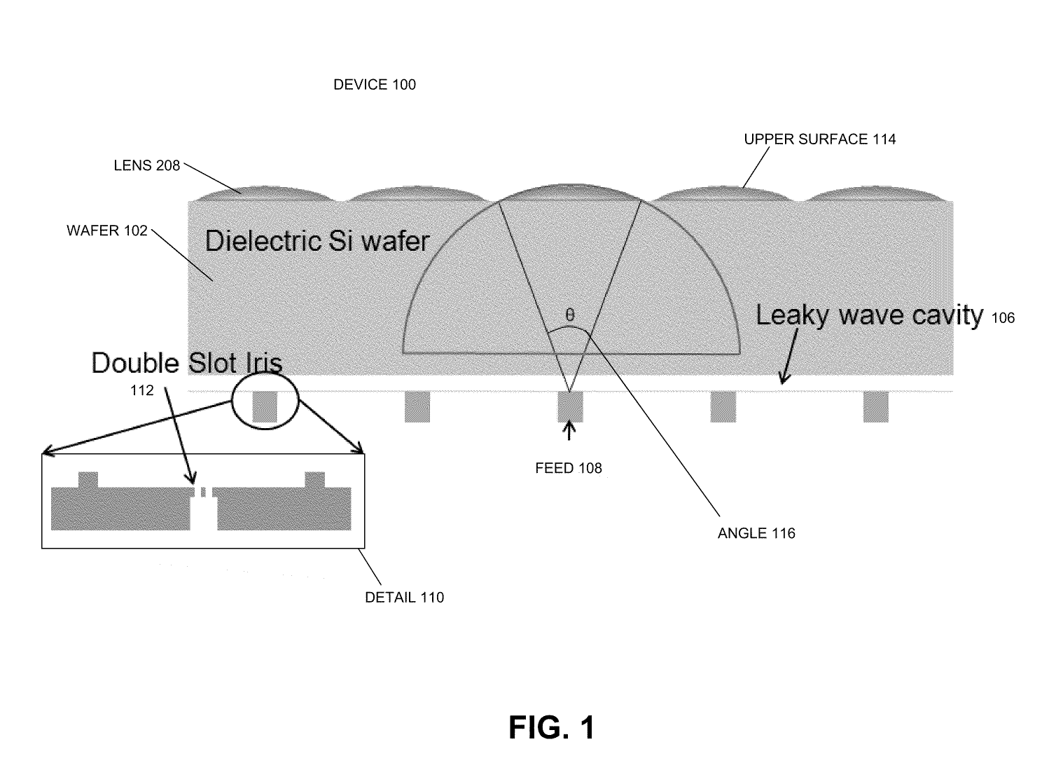

FIG. 1 illustrates a side view of a lens array in accordance with one or more embodiments of the present invention.

Device 100 as shown in FIG. 1 comprises wafer 102, lens 208, cavity 106, and waveguide feed 108. Wave guide feed 108 is shown in detail 110 as optionally further comprising a double slot iris 112 which facilitates energy transfer by matching the antenna impedance into the cavity 106 and wafer 102.

Typically, wafer 102 is a dielectric silicon (Si) slab or wafer, but wafer 102 can be any material that allows for the transmission of the desired wavelengths without departing from the scope of the present invention. Further, lens 208 is typically initially made from photoresist or other material and then the shape of the lens 208 is transferred to wafer 102 through an etching process. Other processes, such as building up the lens 208 from material via Molecular Beam Epitaxy or other methods can also be used in accordance with the present invention.

Thus, typically, the lens 208 is typically made from the material of wafer 102, but depending on the construction, can be of other materials, such as gallium arsenide, indium phosphide, indium antimonide, or other dielectric materials that are substantially transparent at the wavelengths of interest. Further, different materials can be used in conjunction with each other if desired. The lens 208 material properties and shape are based on the ability of the lens 208 material to focus the electromagnetic energy at the wavelengths of interest between the feed 108 and the upper edge 114 of lens 208.

The delivery of electromagnetic radiation to feed 108 (or, alternatively, the transmission of signals from feed 108) is dispersed through cavity 106 and the thickness of wafer 102 at an angle 116. For a silicon wafer 102, this angle is typically 25-35 degrees, but other materials may have a larger or smaller area of transmission. Lens 208 is then applied to the upper surface of wafer 102 such that lens 208 is within the optical/electromagnetic path of the signals travelling between feed 108 and the upper surface 114 of lens 208. Other materials used for wafer 102, as well as lens 208, may have different angles of dispersion of the electromagnetic fields within wafer 102 and lens 208, and thus, such devices 100 could have a different thickness for wafer 102 and/or a different curvature on the upper surface 114 of lens 208 within the scope of the present invention. Further, depending on the wavelengths of interest, the angle of dispersion may also change, and thus the design of device 100 would change accordingly within the scope of the present invention.

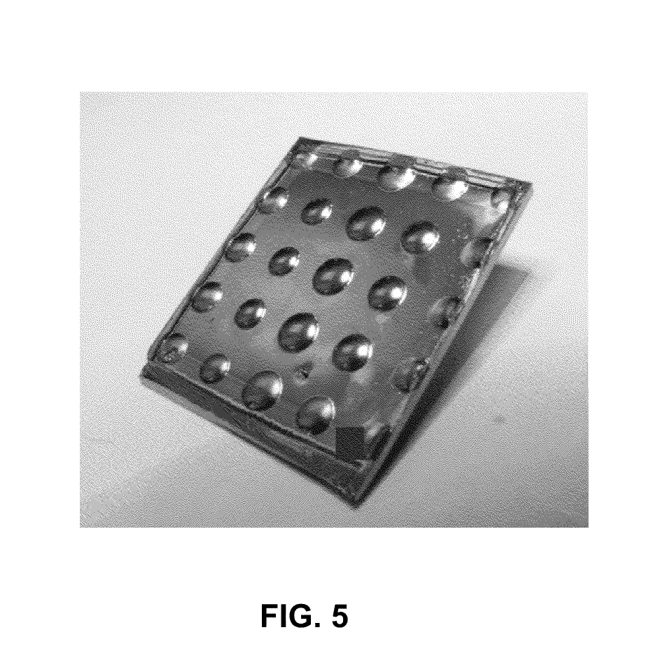

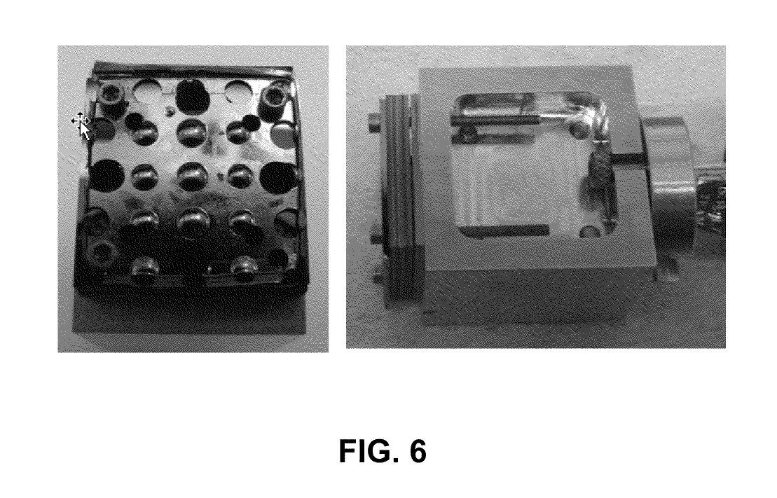

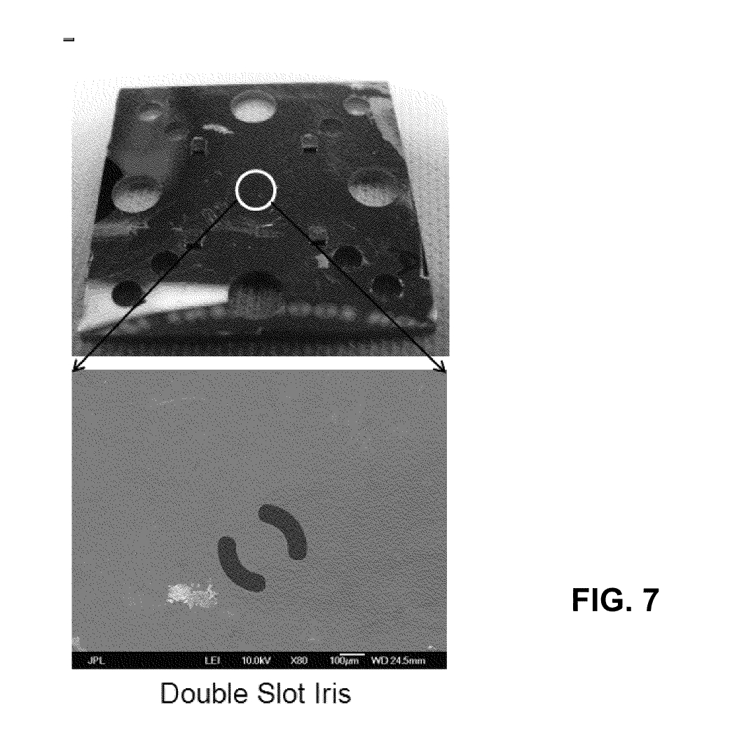

As such, the present invention allows for a small-angle sector lens, which can be fabricated in an array as shown in FIG. 1 and FIG. 5, or as an individual lens if desired, which lenses are easier to fabricate than full hyper-hemispherical lenses. Further, these lenses 208 of the present invention can be fabricated using standard lithographic techniques, and such lenses are easily integrated with the device 100, for use as e.g., a receiver, an antenna, etc. For example, the device 100 of FIG. 1 of the present invention can be a multi-pixel imager/receiver, a transmit antenna, etc.

Lens Implementation

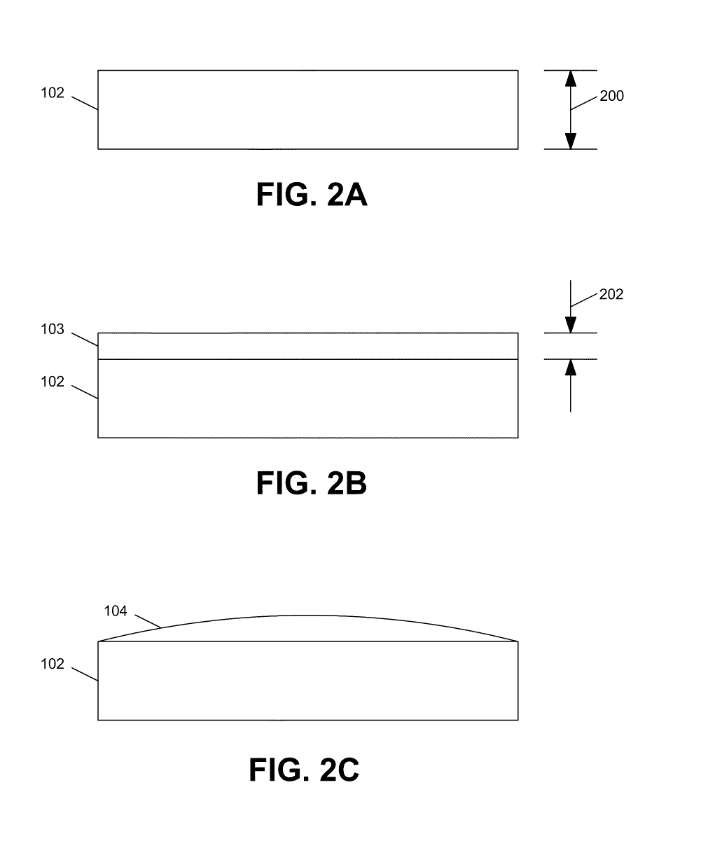

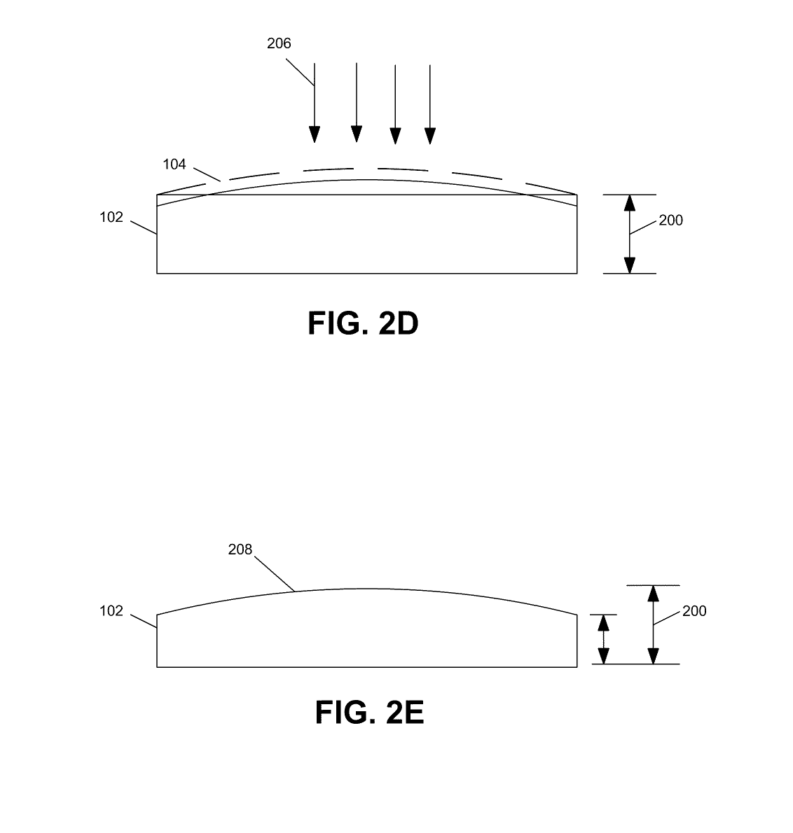

FIGS. 2A-2E illustrate formation of a lens in accordance with one or more embodiments of the present invention.

Wafer 102 is initially selected such that thickness 200 of wafer 102 is appropriate for the wavelengths of interest, and the material of wafer 102 will transmit at the appropriate percentages for the wavelengths of interest.

A layer of material 103, which is typically photoresist but can be other materials, is then applied at a thickness 202. The thickness 202 is selected based on the size of the lens 104 that is to be fabricated from material 103, and, eventually, wafer 102 or other materials that are coupled to wafer 102. Typically, the material 103 is spun onto wafer 102, but other methods of application can be used without departing from the scope of the present invention.

The thickness 202 of photoresist (material 103) is generally determined by the spinning speed and the amount of time that the material 103 is spun. In order to make thicker layers of material 103, e.g., a larger than 1 mm lens, a single coating of photoresist material 103 is insufficient, and thus, once the first layer of material 103 is applied, additional layers of material 103 are added to build up the thickness of material 103 to the desired thickness.

The material 103 is then re-flowed or re-shaped into the desired structure of lens 104. Since this is a batch process, all photoresist lenses 104 on wafer 102 can be formed at the same time. Different sizes of lenses are possible within the present invention by having different thicknesses and/or diameters of lenses 104 prior to etching the wafer 102.

After forming the desired lens shape 104 from material 103 using thermal reflow of material 103, typically by exposing material 103 to higher temperatures, the material 103 forms a lens shape 104 via surface tension. Once the proper shape 104 is formed in the material 103, the shape of material 103 is transferred into wafer 102 via a selective etching process 206, typically Reactive Ion Etching (RIE). If the etching selectivity between material 103 and wafer 102 is 1:1, the exact shape of material 103/lens 104 will be transferred into the wafer 102; other selectivities, e.g., 2:1, 3:1, etc. can be used to create lenses of any shape in wafer 102 without departing from the scope of the present invention. FIG. 2D illustrates the etching 206 removing some of the material 103 (shaped into lens 104) and some of the wafer 102, and FIG. 2E illustrates wafer 102 after all of the material 103 has been removed, and showing that the shape of lens 104 has been transferred into shape 208 of wafer 102. The thickness of wafer 102 has been reduced in some areas to less than the original thickness 200 because of the transfer process of the present invention. By adjusting the etching selectivity, the curvature of lens can also be adjusted. Further, other etching, such as Deep Reactive Ion Etching (DRIE), can be used when large amounts of wafer 102 need to be etched, e.g., >200 microns of wafer 102.

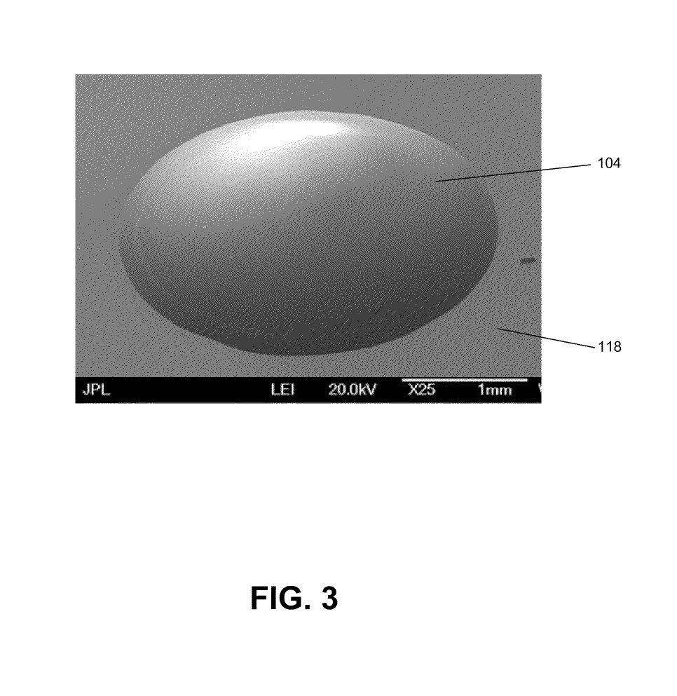

FIG. 3 illustrates a photoresist lens (104) structure after thermal reflow in accordance with one or more embodiments of the present invention.

Lens 104 is shown as a small-angle sector photoresist lens on a top surface 118 of wafer 102. This photoresist lens has been transferred onto the silicon substrate in order to form silicon lens 208 as shown in FIG. 5. The size of lens 104 and/or lens 208 can be measured using the photomicrograph of FIG. 5, and once lens 102 is created and characterized, the alignment of feed 108 with the center of lens 208 is easily accomplished.

Once lens 104 is create with the desired dimensions, the wafer 102 and lens 104 are etched or otherwise treated to transfer the shape and dimensions of lens 104 into wafer 102 as lens 208. As described earlier, wafer 102 may have other materials on the surface of wafer 102 underneath lens 104, such that the dimensions and shape of lens 104 are transferred into these materials as lens 208 without departing from the scope of the present invention. For example, and not by way of limitation, wafer 102 may have a layer of gallium arsenide on top of wafer 102, and the lens 104 shape may be transferred into the layer of gallium arsenide rather than directly into wafer 102. Further, the layer on wafer 102 may only be part of the final lens assembly in the present invention if desired.

Method Steps

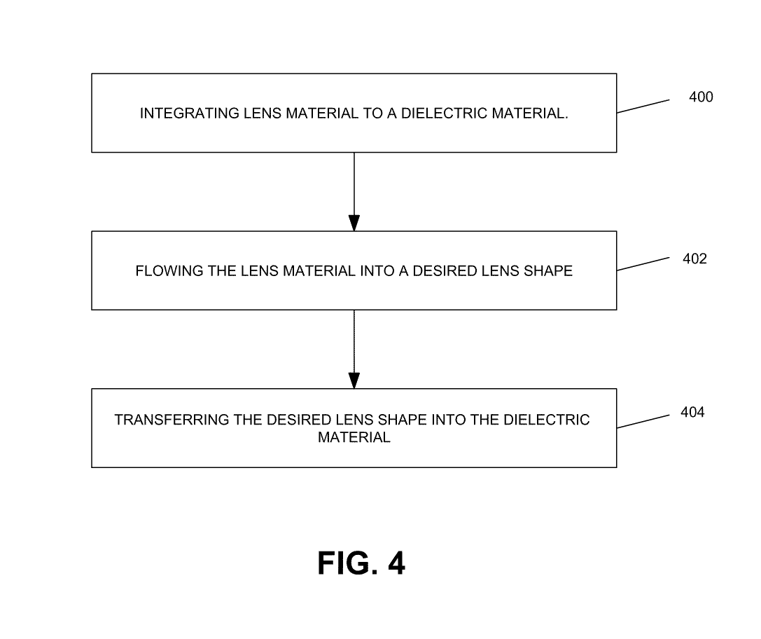

FIG. 4 is a flowchart illustrating a method of fabricating a lens in accordance with one or more embodiments of the present invention.

The method may comprise the following steps.

Block 400 represents integrating lens material with a dielectric material.

Block 402 represents flowing the lens material into a desired lens shape.

Block 406 represents transferring the desired lens shape into the dielectric material.

### ADVANTAGES AND IMPROVEMENTS

The present invention allows for inexpensive, rapid manufacture of lenses and lens arrays for receivers, especially in the millimeter and sub-millimeter wavelength regions. Such lenses and lens arrays also provide weight savings for those receivers that are used in planetary and astronomical instruments where weight is a primary concern. Further, the present invention allows for more precise construction by eliminating many sources of alignment error between feed 108 and lens 208.

### EXAMPLES OF APPLICATIONS

The present invention may be used in single or multi-pixel receivers, preferably in the millimeter wave and sub-millimeter wave regions, for planetary and astronomical instruments, and for security cameras such that concealed objects can be detected.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method of fabricating a lens, comprising:
integrating lens material with a dielectric material;
flowing the lens material into a desired lens shape; and
transferring the desired lens shape into the dielectric material.

2. The method of claim 1, wherein the lens material is photoresist.

3. The method of claim 2, wherein integrating the lens material comprises multiple applications of photoresist.

4. The method of claim 1, wherein the dielectric material is a silicon wafer.

5. The method of claim 1, wherein the desired lens shape is based on electromagnetic dispersion through the dielectric material.

6. The method of claim 1, wherein the lens is an array of lenses.

7. An integrated lens antenna, comprising:
a dielectric material;
a waveguide feed, coupled to the dielectric material through a leaky wave cavity and
a waveguide iris; and
a lens, coupled to the dielectric material opposite the leaky wave cavity, wherein lens material is first deposited onto the dielectric material, flowed into a desired lens shape, and the desired lens shape is transferred to the dielectric material to form the lens.

8. The integrated lens antenna of claim 7, wherein the lens material is photoresist.

9. The integrated lens antenna of claim 7, wherein the dielectric material is a silicon wafer.

10. The integrated lens antenna of claim 7, wherein the desired lens shape is based on electromagnetic dispersion through the dielectric material.

11. The integrated lens antenna of claim 7, wherein the waveguide feed comprises a double slot iris.

12. The integrated lens antenna of claim 7, wherein the lens is an array of lenses.

13. A multi-pixel receiver having an integrated lens antenna, comprising:
a plurality of waveguide feeds;
a dielectric material coupled to the plurality of waveguide feeds; and
a plurality of lenses coupled to the dielectric material opposite the plurality of waveguide feeds, wherein lens material is first deposited onto the dielectric material, flowed into a desired lens shape for each lens in the plurality of lenses, and the desired lens shape for each lens in the plurality of lenses is transferred to the dielectric material to form the plurality of lenses.

14. The multi-pixel receiver of claim 13, wherein the lens material is photoresist.

15. The multi-pixel receiver of claim 13, wherein the dielectric material is a silicon wafer.

16. The multi-pixel receiver of claim 13, wherein the desired lens shape is based on electromagnetic dispersion through the dielectric material.

17. The multi-pixel receiver of claim 13, wherein the waveguide feed comprises a double slot iris.
